(19) United States
(12) Patent Application Publication
(10) Pub. No.: US 2005/0153815 A1
(43) Pub. Date: Jul. 14, 2005

(54) Method for operating an automatic transmission of a turbochargerd internal combustion engine

(76) Inventor: Peter Janssen, Maasbracht (NL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/520,669

(22) PCT Filed: Jul. 14, 2003
(86) PCT No.: PCT/EP03/07571

(30) Foreign Application Priority Data
Jul. 29, 2002 (DE) 102 344 428.0

(51) Int. Cl. F16H 61/58

(52) U.S. Cl. 477/62

(57) ABSTRACT

The invention relates to a method for operating an automatic transmission, having a torque converter and at least one function clutch, of a motor vehicle having an internal combustion engine with a rising torque characteristic in the lower rotational speed range, in particular an internal combustion engine charged by means of a turbocharger, in which method the starting operation is carried out via the torque converter, during the starting of the motor vehicle the function clutch used in this case initially being induced to slip during a short predetermined period of time until a starting torque which is increased, as compared with idling, has built up.

The invention relates to a method for operating an automatic transmission of a turbocharger-charged internal combustion engine according to the preamble of claim 1.

Internal combustion engines charged by means of a turbocharger always have a weak starting behaviour, as compared with aspirating engines of the same strength, since the turbocharger must first deliver sufficient boost pressure before the full torque is available. This applies particularly in conjunction with a converter automatic transmission. The deployment of power also has an inhomogeneous action in this case.

The reason for this starting behaviour is based on the characteristic of the torque converter which, at an operating point, rises by the square of the engine rotational speed. This leads to a run-up of the internal combustion engine under a load which rises quickly with the engine rotational speed and thus prevents high engine rotational speeds.

An internal combustion engine charged by means of a turbocharger, however, in the idling rotational speed range has virtually no boost pressure and therefore only a little immediately available power. So that boost pressure and therefore torque can be built up quickly, the internal combustion engine would have to be run up quickly so that there is sufficient exhaust gas to operate the turbocharger. However, a rapid run-up is inhibited by the characteristic of the torque converter.

The object of the invention is, therefore, to provide a method according to the preamble of claim 1, in order to improve the starting behaviour of an internal combustion engine charged by means of a turbocharger.

This object is achieved according to the characterizing clause of claim 1.

In an automatic transmission comprising a torque converter and at least one function clutch, by means of which, for example, the gear is selected (N_D shift) or a gear shift is carried out, the torque converter conventionally serves as a starting element, the function clutches being of too weak a design and consequently unsuitable as a starting element. However, since, during the starting of the motor vehicle, the corresponding function clutch is initially induced to slip in a controlled manner during a short predetermined period of time in which a sufficient boost pressure is built up by the turbocharger, the internal combustion engine can run up virtually freely, so that exhaust gas for driving the turbocharger is correspondingly generated. On account of the small period of time, which is preferably in the range of about 100 to 250 ms and in which the function clutch is induced to slip, the function clutch is already closed again when the full engine torque and full converter gain are available. The actual starting operation subsequently takes place by the torque converter.

Since the slip phase is very short and is in a range in which there is still no high torque available, the introduction of power at the function clutch remains low. This can therefore be managed by a normal function clutch. It is estimated that the introduction of power into the function clutch amounts at most to half a full-load upshift.

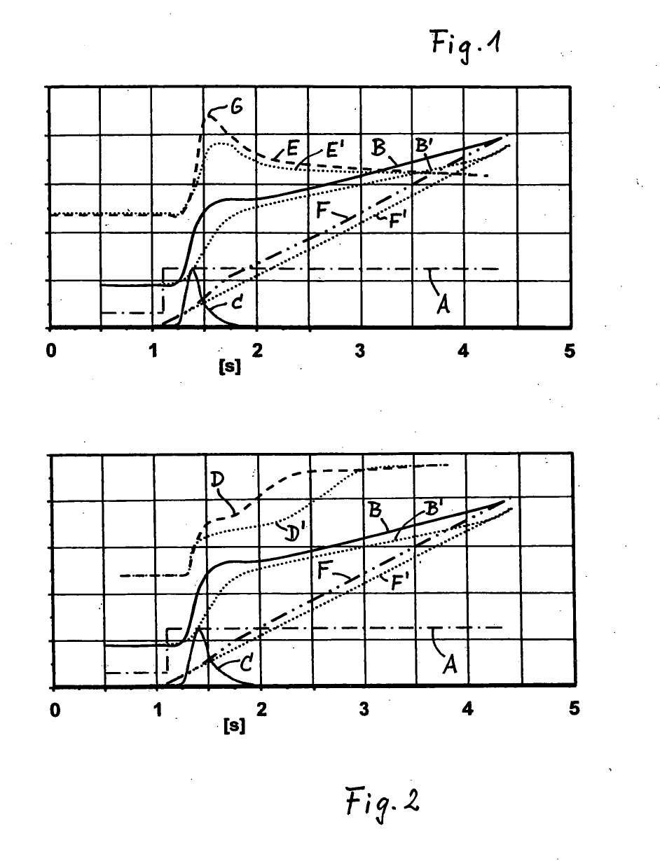

FIGS. 1 and 2 show in each case diagrammatically a graph with a typical image of driving behaviour with and without assistance.

These illustrate in each case on the abscissa, the time in [s] and, on the ordinate, in arbitrary units, the pedal actuation, vehicle acceleration, engine rotational speed, turbine rotational speed of the function clutch, vehicle speed and engine torque.

At a defined time, the pedal is depressed in order to start the motor vehicle, this being illustrated by the curve A which is subjected to an abrupt change in order to make even clearer the difference between the starting operations with and without assistance when the pedal is depressed. The engine rotational speed, which is illustrated by the curve B with assistance and by the curve B′ without assistance, initially has idling rotational speed and rises with a slight time delay after the actuation of the pedal. A rise in the engine rotational speed simultaneously has the effect that the function clutch begins to slip, in order to cause the assistance of the starting operation. The turbine rotational speed of the function clutch is illustrated in the curve C, this being zero during idling. The rising flank of the curve C extends over a predetermined period of time (here, for example, about 100 ms). The turbine rotational speed of the function clutch thereafter falls again to zero. The integral across the curve C constitutes the introduction of power into the function clutch, that is to say the heat to be absorbed by the latter.

By the function clutch being induced to slip, the engine rotational speed increases, according to the curve B, more quickly than without assistance. As a result, the engine torque (curve D with assistance and curve D′ without assistance) and consequently the acceleration (curve E with assistance and curve E′ without assistance) are also increased correspondingly, so that the vehicle speed (curve F with assistance and curve F′ without assistance) rises correspondingly in the range in which the function clutch slips, as compared with a vehicle speed without assistance according to curve F′.

As illustrated in FIGS. 1 and 2, therefore, owing to the starting assistance as a result of the brief slip of the function clutch, an improved starting performance and an improved spontaneity of the drive train, with an acceleration peak G, are obtained at the commencement of starting. Furthermore, improved driving performance data are thereby acquired, and the reaching of a predetermined final speed from zero is improved, as may be gathered from a comparison of curves F and F′. Moreover, a more homogeneous deployment of power is achieved. To that extent, although the converter is used for starting, the starting behaviour corresponds in behaviour to a combination of the positive properties of a converter and of a wet oil-cooled clutch otherwise used alternatively in automatic transmissions. Moreover, these advantages are irrespective of whether a converter clutch is or is not used later during starting.

Even in internal combustion engines without turbocharging, which have a rising torque characteristic, the corresponding advantages described are obtained, but these are less pronounced than in an internal combustion engine with turbocharging.

By the function clutch being induced to slip, particularly during the starting of the motor vehicle, the converter characteristic is adapted to the respective dynamic operating point.

1-4. (canceled)

5. A method for operating an automatic transmission, having a torque converter and at least one function clutch, of a motor vehicle having an internal combustion engine with a rising torque characteristic in the lower rotational speed range, in particular an internal combustion engine charged by means of a turbocharger, in which method the starting operation is carried out via the torque converter, characterized in that, during the starting of the motor vehicle, the function clutch used in this case is initially induced to slip during a short predetermined period of time until a starting torque which is increased, as compared with idling, has built up.

6. The method according to claim 5, characterized in that the predetermined period of time is set at a time of between about 100 and about 1000 ms, in particular of between about 100 and about 250 ms.

7. The method according to claim 5, characterized in that the function clutch is induced to slip until a sufficient boost pressure is built up by the turbocharger.

8. The method for operating an automatic transmission, having a torque converter and at least one function clutch, of a motor vehicle having an internal combustion engine with a rising torque characteristic in the lower rotational speed range, in particular an internal combustion engine charged by means of a turbocharger, in which method the starting operation is carried out via the torque converter, characterized in that a function clutch is controlled in such a way that the converter characteristic is thereby adapted to the respective dynamic operating point.
